(19) United States
(12) Patent Application Publication
(10) Pub. No.: US 2024/0063922 A1
(43) Pub. Date: Feb. 22, 2024

(54) MULTIPLE REPETITIVE RESOURCES FOR RADIO-FREQUENCY CALIBRATION

(71) Applicant: Sony Group Corporation, Tokyo (JP)

(72) Inventors: Fredrik RUSEK, Eslöv (SE); Kun ZHAO, Malmö (SE); Olof ZANDER, Södra Sandby (SE); Jose FLORDELIS, Lund (SE); Erik BENGTSSON, Eslöv (SE)

(21) Appl. No.: 18/270,522

(22) PCT Filed: Jan. 14, 2022
(86) PCT No.: PCT/EP2022/050736

§ 371 Date: Jun. 30, 2023

(30) Foreign Application Priority Data
Jan. 15, 2021 (SE) 2150035-0

(51) Int. Cl. H04B 17/11; H04B 17/21

(52) U.S. Cl. CPC H04B 17/11; H04B 17/21

(57) ABSTRACT

A method of operating a wireless communication device (102) connectable to a communications network (100) includes obtaining an indication of multiple repetitive resources (370) that the wireless communication device (102) is allowed to use for performing a calibration of one or more radio-frequency components; and prior to performing the calibration: selecting at least one resource from the multiple repetitive resources for performing the calibration.

### BACKGROUND

Wireless communication using wireless communication devices (UEs) is widespread. Electromagnetic waves are used to transmit signals encoding data. Wireless interfaces of the participating devices employ radio-frequency (RF) components. From time to time, a calibration of the RF components may be required.

While performing the calibration, a transmission of payload data can be temporarily suspended, to allow the UE to, e.g., transmit calibration signals and/or run self-checks. Such suspending of the transmission of payload data is sometimes referred to as an uplink calibration gap (UCG).

It has been observed that performing the calibration at a UE can cause interference at one or more further UEs and/or at a base station. Further, finding an appropriate timing for the UCG can be challenging. Also, where resources are allocated to a UE performing the calibration, scheduling of the UE and/or further UEs can be complicated.

### SUMMARY

Accordingly, there is a need for advanced techniques of performing a calibration of one or more RF components. There is a need for advanced techniques of configuring the calibration.

This need is met by the features of the independent claims. The features of the dependent claims define embodiments.

A method of operating a UE that is connectable to a communications network includes obtaining an indication of multiple repetitive resources. The UE is allowed to use the multiple repetitive resources for performing a calibration of one or more RF components. The method also includes, prior to performing the calibration of the one or more RF components of the UE, selecting at least one resource from the multiple repetitive resources for performing the calibration.

A computer program or a computer-program product or a computer-readable storage medium includes program code. The program code can be loaded and executed by at least one processor. Loading and executing the program code causes the at least one processor to perform a method of operating a UE. The UE is connectable to a communications network. The method includes obtaining an indication of multiple repetitive resources. The UE is allowed to use the multiple repetitive resources for performing a calibration of one or more RF components. The method also includes, prior to performing the calibration of the one or more RF components of the UE, selecting at least one resource from the multiple repetitive resources for performing the calibration.

A UE that is connectable to a communications network includes a control circuitry. The control circuitry is configured to obtain an indication of multiple repetitive resources. The UE is allowed to use the multiple repetitive resources for performing a calibration of one or more RF components. The UE is also configured to select at least one resource from the multiple repetitive resources for performing the calibration, prior to performing the calibration.

A method of operating a node of a communications network—e.g., a base station—is provided. The method includes obtaining an indication of multiple repetitive resources allocated to a UE for performing a calibration of one or more RF components of the UE. The method also includes scheduling and uplink calibration gap for the UE for at least one resource of the multiple repetitive resources.

A computer program or a computer-program product or a computer-readable storage medium includes program code. The program code can be loaded and executed by at least one processor. Loading and executing the program code causes the at least one processor to perform a method of operating a node of a communications network. The method includes obtaining an indication of multiple repetitive resources allocated to a UE for performing a calibration of one or more RF components of the UE. The method also includes scheduling and uplink calibration gap for the UE for at least one resource of the multiple repetitive resources.

A node of a communications network includes control circuitry that is configured to obtain an indication of multiple repetitive resources. The multiple repetitive resources are allocated to a UE for performing a calibration of one or more RF components of the UE. The control circuitry is also configured to schedule an uplink calibration gap for the UE for at least one resource of the multiple repetitive resources.

A method of operating a UE is provided. The UE is connectable or connected to a communications network. The method includes communicating at least one control message between the UE and the communications network. The at least one control message includes assistance information for performing a calibration of one or more RF components of the UE. The method includes performing the calibration in accordance with the assistance information.

For instance, the assistance information could include a timing of an uplink calibration gap. A start time and/or an end time of the uplink calibration gap could be indicated.

The assistance information could include a request for an uplink calibration gap. A further one of the at least one control message could then include a positive or a negative acknowledgment of the request.

The at least one control message could be indicative of the calibration having been completed.

The at least one control message could include a network trigger for triggering the calibration at the UE.

It is to be understood that the features mentioned above and those yet to be explained below may be used not only in the respective combinations indicated, but also in other combinations or in isolation.

### BRIEF DESCRIPTION OF THE DRAWINGS

FIG. 1 schematically illustrates a communication system including a UE and a base station according to various examples.

FIG. 2 schematically illustrates details of the UE and the base station according to various examples.

FIG. 3 schematically illustrates multiple beams used by the UE according to various examples.

FIG. 4 schematically illustrates an example implementation of a communications network (NW) as a cellular NW.

FIG. 5 schematically illustrates multiple operational modes in which a UE can operate.

FIG. 6 schematically illustrates uplink calibration gaps during which the UE can perform a calibration of RF components according to various examples.

FIG. 7 is a flowchart of a method according to various examples.

FIG. 8 is a signaling diagram of communication between the UE and the base station related to the UE performing a calibration of its RF components according to various examples.

FIG. 9 is a flowchart of a method according to various examples.

FIG. 10 schematically illustrates multiple repetitive resources allocated to a UE performing a calibration according to various examples.

FIG. 11 is a flowchart of a method according to various examples.

### DETAILED DESCRIPTION OF EMBODIMENTS

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, various techniques of wirelessly transmitting and/or receiving (communicating) payload data in a communication system will be described. Payload data can be data on Layer 3 or higher, e.g., Layer 7. Payload data could be application data, e.g., of one or more applications executed by the UE such as an Internet browser, messaging, social media, multimedia streaming. Payload data can also include higher-layer control messages, e.g., Radio Resource Control (RRC) control messages.

A communication system can include multiple UEs and/or nodes that participate in a transmission of payload data. A UE operates one or more RF components. These radio frequency components can include RF switches, tunable RF filters, amplifiers, phase shifters, and/or mixers, etc.

It has been observed that for a reliable transmission of payload data, it is oftentimes helpful to perform a calibration of one or more of such RF components from time to time. This, in particular, applies for comparably high frequencies of the carriers, e.g., above 6 GHz or even above 15 GHz.

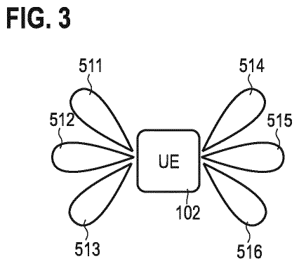

Generally in the various examples disclosed herein, performing the calibration can include setting operational properties of the one or more RF components. For instance, an RF clock can be tuned to a certain reference phase. Amplifiers can be calibrated to a certain reference gain; a frequency response of amplifiers can be measured to compensate for non-linearities. Phase relationships between multiple antenna elements used for Multiple Input Multiple Output (MIMO) transmission can be calibrated. Transmit power levels can be calibrated. And adjacent channel leakage ratio (ACLR) can be detected and the RF components can be set accordingly to compensate for the leakage. A further example of performing the calibration can include adjusting or reducing timing offsets between multiple antenna panels of the UE (antenna panels will be discussed in connection with FIG. 3): There may be some residual timing offsets in the timing references between panels, e.g., induced by temperature differences and time-varying (drift). Even small timing offset can have a severe impact on positioning estimates based on time-difference-of-arrival measurements by the UE.

Oftentimes, such performing of a calibration of one or more RF components can include a respective UE transmitting signals using the RF components (these signals will be labeled calibration signals; they could be of arbitrary shape or even encode data). One or more properties of the operation of the one or more RF components can be monitored when transmitting the calibration signals and based on such monitoring, it may then possible to set operational properties of the one or more RF components or adjust the transmitting and/or receiving in accordance with sensed operational properties. For example, a pre-distortion vector can be updated. A self-calibration is thus possible.

Because transmitted calibration signals are monitored, the calibration can also be referred to as uplink (UL) calibration.

The calibration can be performed during an uplink calibration gap (UCG). During the uplink calibration gap, the transmission of payload can be temporarily suspended, in order to enable the UE to perform the calibration. More generally, according to the various examples described herein it would be possible to suspend all transmissions to and from the communications network during the UCG. After the calibration, payload data can be communicated again. Thus, a base station (BS) schedules the UCG so that the transmission of payload data is temporarily suspended.

Various techniques facilitate the UE performing the calibration. According to the techniques described herein, it is possible to reduce a risk that the calibration causes interference to other devices. Scheduling of the UCG and—where appropriate—of one or more resources allocated to the UE performing the calibration can be simplified. Control signaling overhead can be reduced according to various examples.

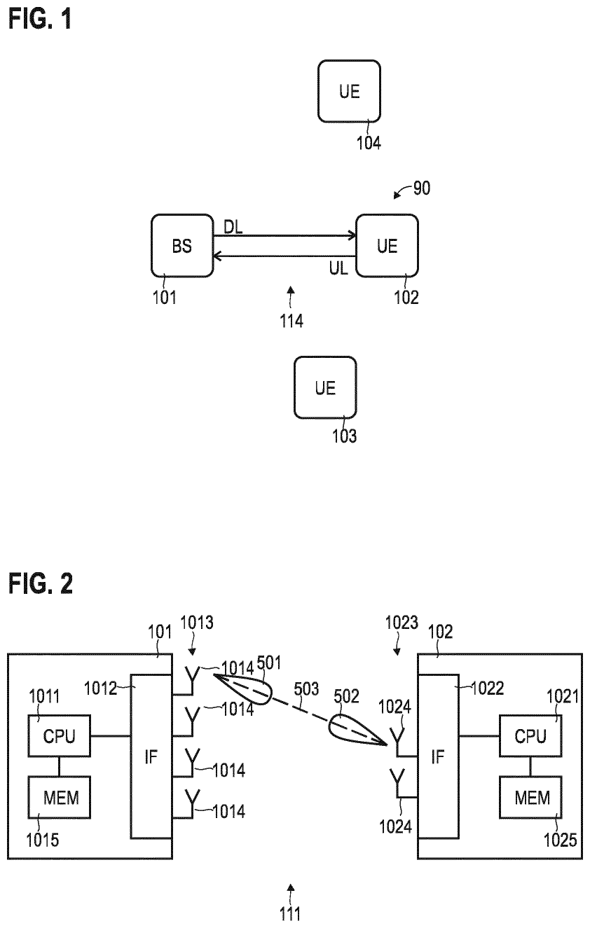

FIG. 1 schematically illustrates a wireless communication system 90 that may benefit from the techniques disclosed herein. The wireless communication system 90 includes a UE 102 and a base station (BS) 101 of a radio-access network (RAN) of a cellular NW 100.

There are further UE 103, 104 arranged in a neighborhood of the UE 102. The UE 102—when performing a calibration of one or more RF components—can cause interference to the UE 103, 104 attempting to communicate with the BS 101. Specifically, it would be possible that uplink transmissions from the UE 103 or the UE 104 to the BS 101 are disturbed by the calibration performed by the 102. For example, calibration signals can occupy the spectrum and make it difficult to sense the signals of the uplink transmissions.

As a general rule, the techniques described herein may be applicable to cellular NWs of various kinds and types. For instance, the cellular NW 100 may be a 3GPP-standardized cellular NW such as 4G Long Term Evolution (LTE) or 5G NR.

A wireless link 114 is established between the BS 101 and the UE 102. Downlink communication is implemented from the BS 101 to the UE 102. Uplink communication is implemented from the UE 102 to the BS 101.

The UE 102 may be one of the following: a smart phone; a cellular phone; a tablet PC; a notebook; a computer; a smart TV; a machine type communication device; an IOT device; etc.

Further details of the BS 101 and the UE 102 are explained in connection with FIG. 2.

FIG. 2 illustrates details with respect to the BS 101. The BS 101 includes control circuitry that is implemented by a processor 1011 and a non-volatile memory 1015. The processor 1011 can load program code that is stored in the memory 1015. The processor 1011 can then execute the program code. Executing the program code causes the processor to perform techniques as described herein, e.g.: transmitting and/or receiving signals encoding payload data to and/or from the UE 102, to thereby participate in a transmission of payload data between the BS 101 and the UE 102; temporarily suspend said transmission of the payload data during an UCG; determining at least one resource—i.e., a time-frequency resource of a time-frequency resource grid—allocated to the UE 102 performing the calibration and during the UCG; providing a configuration associated with said performing of the calibration to the UE 102, the configuration defining one or more properties of the calibration, e.g., a timing of the UCG, at least one resource allocated to the UE 102 performing the calibration, one or more beams to be used for performing the calibration, and/or calibration signals to be used when performing the calibration; scheduling an UCG; scheduling multiple UEs, e.g., to share one or more resources or to use different resources; etc.

FIG. 2 also illustrates details with respect to the UE 102. The UE 102 includes control circuitry that is implemented by a processor 1021 and a non-volatile memory 1025. The processor 1021 can load program code that is stored in the memory 1025. The processor can execute the program code. Executing the program code causes the processor to perform techniques as described herein, e.g.: transmitting and/or receiving signals encoding payload data to and/or from the base station 101, to thereby participate in a transmission of payload data between the base station 101 and the UE 102; temporarily suspending said transmission of the payload data during an UCG; performing the calibration during the UCG, wherein said performing of the calibration may include transmitting calibration signals; monitoring transmitting of calibration signals when performing the calibration and setting one or more operational properties of one or more RF components of a wireless interface of the UE 102 based on said monitoring; obtaining a configuration associated with said performing of the calibration from the BS 101, the configuration defining one or more properties of the calibration, e.g., a timing of the UCG, at least one resource allocated to the UE 102 for performing the calibration, one or more beams to be used for performing the calibration, and/or calibration signals to be used when performing the calibration, etc.

FIG. 2 also illustrates details with respect to communication between the BS 101 and the UE 102 on the wireless link 114. The BS 101 includes an interface 1012 that can access and control multiple antennas 1014. Likewise, the UE 102 includes an interface 1022 that can access and control multiple antennas 1024.

While the scenario of FIG. 2 illustrates the antennas 1014 being coupled to the BS 101, as a general rule, it would be possible to employ transmit-receive points (TRPs) that are spaced apart from the BS.

The interfaces 1012, 1022 can each include one or more TX chains and or more RX chains, implemented by RF components. For instance, such RX chains can include low noise amplifiers, analogue to digital converters, mixers, etc. Analog and/or digital beamforming would be possible. Such and other RF components can be subject to calibration, as explained in various examples herein.

Phase-coherent communicating can be implemented across the multiple antennas 1014, 1024. Thereby, the BS 101 and the UE 102 implement a MIMO communication system.

As a general rule, the receiver of the MIMO communication system receives a signal y that is obtained from an input signal x multiplied by a radio channel matrix H.

The radio channel matrix H defines the channel transfer function at a certain subcarrier of an OFDM system of the wireless link 114. The number of independent columns or rows of H defines the rank of the radio channel. H may support several transmissions modes, all of them having a number of layers not greater than the rank of the channel. The number of layers of a transmission mode can be called the rank of the transmission mode. The rank can be different for different MIMO transmission modes. For MIMO transmission modes, the amplitude and/or phase (antenna weights) of each one of the antennas 1014, 1024 is appropriately controlled by the interfaces 1012, 1022.

For instance, one possible transmission mode can be a diversity MIMO transmission mode. Another MIMO transmission mode is spatial multiplexing. Spatial multiplexing enables an increase to the data rate if compared to a reference scenario in which a single data stream of similar throughput is used. The data is divided into different spatial streams and these different data streams can be transmitted contemporaneously over the wireless link 114.

The diversity MIMO transmission mode and the spatial multiplexing multi-antenna transmission mode can be described as using multiple beams, the beams defining the spatial data streams. These modes are, therefore, also referred to as multi-beam operation. By using a beam, the direction of the wavefront of signals transmitted by a transmitter of the communication system is controlled. Energy is focused into a respective direction, by phase-coherent superposition of the individual signals originating from each antenna 1014, 1024. Thereby, the spatial stream can be directed. The spatial streams transmitted on multiple TX beams can be independent, resulting in spatial multiplexing multi-antenna transmission; or dependent on each other, e.g., redundant, resulting in diversity MIMO transmission. As a general rule, alternatively or additionally to such TX beams, it is possible to employ RX beams.

FIG. 2 illustrates two beams 501-502 and an associated spatial stream 503. Based on the assumption of beam reciprocity, each TX beam can be associated with an associated RX beam, at the same device, that has corresponding spatial characteristics (and vice versa).

FIG. 3 schematically illustrates aspects with respect to multiple beams 511-516 used by the UE 102. In the illustrated example of FIG. 3, multiple antenna panels are used, one antenna panel for the beams 511-513 and the second antenna panel for the beams 514-516. Each antenna panel can have a set of antenna elements configured so that the respective beams 511-513, 514-516 point into different solid angles in the surrounding of the UE 102.

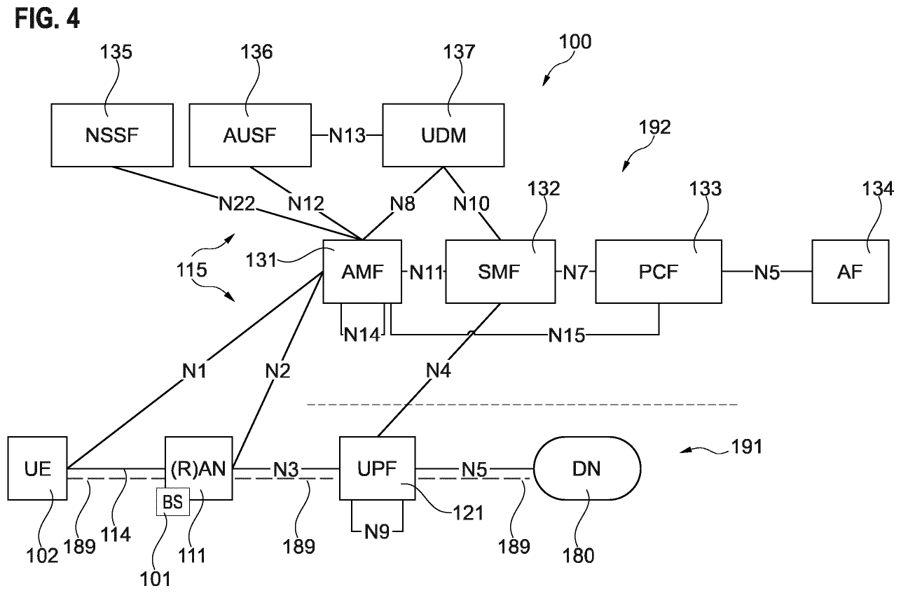

FIG. 4 schematically illustrates an example implementation of the cellular NW 100 in greater detail. The example of FIG. 4 illustrates a cellular NW 100 according to the 3GPP 5G architecture. Details of the fundamental architecture are described in 3GPP TS 23.501, version 1.3.0 (2017 September). While FIG. 4 and further parts of the following description illustrate techniques in the 3GPP 5G framework, similar techniques may be readily applied to different communication protocols. Examples include 3GPP LTE 4G and IEEE Wi-Fi technology.

The UE 102 is connectable to the cellular NW 100 via a radio-access network (RAN) 111, typically formed by one or more BSs 101. The wireless link 114 is established between the RAN 111—specifically between one or more of the BSs 101 of the RAN 111—and the UE 102, thereby implementing the communication system 90 (cf. FIG. 1).

The RAN 111 is connected to a core NW (CN) 115. The CN 115 includes a user plane (UP) 191 and a control plane (CP) 192. Application data is typically routed via the UP 191. For this, there is provided a UP function (UPF) 121. The UPF 121 may implement router functionality. Payload data may pass through one or more UPFs 121. In the scenario of FIG. 4, the UPF 121 acts as a gateway towards a data NW (DN) 180, e.g., the Internet or a Local Area NW. The payload data can be communicated between the UE 102 and one or more servers on the DN 180.

The NW 100 also includes an Access and Mobility Management Function (AMF) 131; a Session Management Function (SMF) 132; a Policy Control Function (PCF) 133; an Application Function (AF) 134; a NW Slice Selection Function (NSSF) 134; an Authentication Server Function (AUSF) 136; and a Unified Data Management (UDM) 137. FIG. 3 also illustrates the protocol reference points N1-N22 between these nodes.

The AMF 131 provides one or more of the following functionalities: registration management; NAS termination; connection management; reachability management; mobility management; access authentication; and access authorization. The AMF 131 may keep track of UE context of the UE 102 when a data connection 189 is established and when the UE 102 operates in a connected mode. The AMF 131 may keep track of a need for performing a calibration by the UE 102, e.g., a timing associated with UCGs or a guaranteed availability of UCGs.

A data connection 189 is established by the AMF 131 when the respective UE 102 operates in the connected mode. To keep track of the current NW registration mode of the UEs 102, the AMF 131 sets the UE 102 to Evolved Packet System Connection Management (ECM) connected or ECM idle. During ECM connected, a non-access stratum (NAS) connection is maintained between the UE 102 and the AMF 131. The NAS connection implements an example of a mobility control connection. The NAS connection may be set up in response to paging of the UE 102.

The SMF 132 provides one or more of the following functionalities: session management including session establishment, modify and release, including bearers set up of UP bearers between the RAN 111 and the UPF 121; selection and control of UPFs;

configuring of traffic steering; roaming functionality; termination of at least parts of NAS messages; etc.

FIG. 4 also illustrates aspects with respect to the data connection 189. The data connection 189 is established between the UE 102 via the RAN 111 and the UP 191 of the CN 115 and towards the DN 180. For example, a connection with the Internet or another packet data NW can be established. To establish the data connection 189, it is possible that the respective UE 102 performs a random-access (RA) procedure (e.g., a 2-step or 4-step RA procedure), e.g., in response to reception of a paging signal. A server of the DN 180 may host a service for which payload data (sometimes also referred to as application data) is communicated via the data connection 189. The data connection 189 may include one or more bearers such as a dedicated bearer or a default bearer. The data connection 189 may be defined on the Radio Resource Control (RRC) layer, e.g., generally Layer 3 of the OSI model of Layer 2. The data connection can support logical channels, e.g., a Physical Downlink Shared Channel (PDSCH) and a Physical Uplink Shared Channel (PUSCH) for communicating payload data.

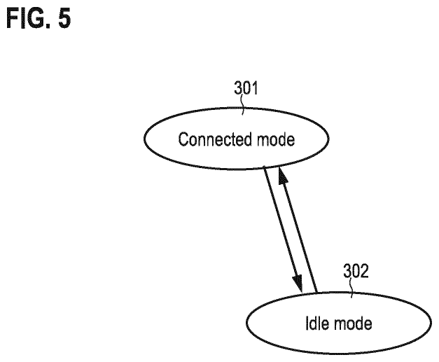

FIG. 5 illustrates aspects with respect to different NW operational modes 301-302 (also referred to as registration modes) in which the UE 102 can operate. Example implementations of the operational modes 301-302 are described, e.g., in 3GPP TS 38.300, e.g., version 15.0.

During a connected mode 301, the data connection 189 is set up and is maintained set-up. For example, a default bearer and optionally one or more dedicated bearers may be set up between the UE 102 and the NW 100. The receiver of the UE 102 may persistently operate in an active state or may implement a DRX cycle. The DRX cycle includes ON durations and OFF durations, according to a respective timing schedule. During the OFF durations, the receiver is unfit to receive data; an inactive state of the receiver may be activated.

To achieve a power reduction, it is possible to implement an idle mode 302. When the UE 102 operates in the idle mode 302, the data connection 189 is not established. The data connection 189 can be released when transitioning from the connected mode 301 to the idle mode 302, e.g., using a respective RRC release control message. The idle mode 302 is associated with the DRX cycle of the receiver of the UE 102. However, during the on durations of the DRX cycle in idle mode 302, the receiver is only fit to receive paging indicators and, optionally, paging messages. For example, this may help to restrict the particular bandwidth that needs to be monitored by the receiver during the on durations of the DRX cycles in idle mode 302. The receiver may be unfit to receive payload data. This may help to reduce the power consumption—e.g., if compared to the connected mode 301.

To transition from the idle mode 302 to the connected mode 301, the UE 102 can perform a RA procedure. The RA procedure typically includes two or four messages. As a first message, the UE 102 transmits a RA preamble. The RA preamble is selected by the UE from multiple candidate RA preambles in particular, the RA procedure can be contention-based. This means that it can occur that two or more UEs transmit the same RA preamble using the same at least one resource. It is also possible that two or more UEs transmit different RA preambles using the same at least one resource. Thus, it is possible that collision occurs; the RA procedure is configured to provide for means to resolve such collision, e.g., by performing a random back-off. Also, the RA preambles are designed so that collision can at least in some instances be resolved in code domain. In some scenarios, it is possibly to transmit payload data during the RA procedure (early data transfer, EDT).

Typically, the transmission for transmission of payload data, the UE 102 transitions to the connected mode 301. Then, the payload data can be communicated using the data connection 189. For example, payload data can be communicated on the PUSCH and/or PDSCH. Yet, in some scenarios, it is possible to communicate a size-limited amount of UL payload data even without having the data connection 189 established and prior to performing the RA procedure (i.e., before EDT). In particular, it is possible that multiple repetitive resources are allocated to transmitting signals while the UE operates in the idle mode 302, i.e., without performing a RA procedure. For example, the multiple repetitive resources can be requested and configured prior to transitioning to the idle mode 302, while the UE 102 operates in the connected mode 301. Such repetitive resources are referred to as pre-configured UL resources (PUR). PUR is described in 3GPP Technical Specification (TS) 36.330 V16.3.0 (2020 September), section 7.3d.

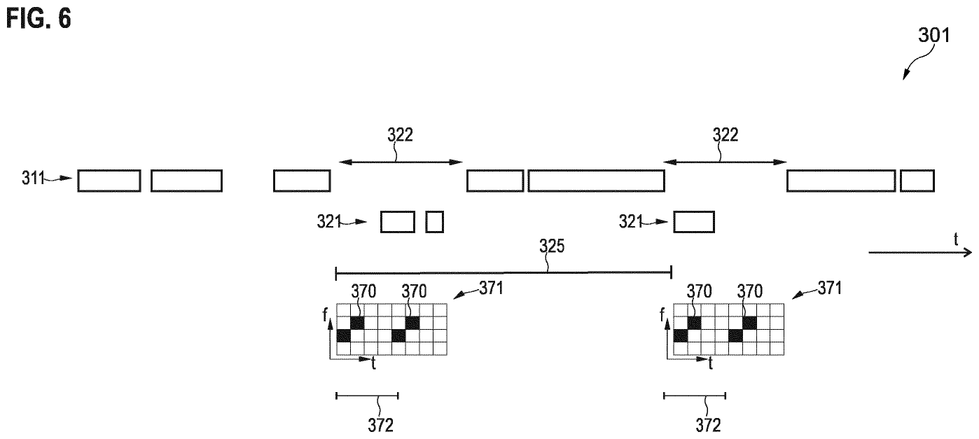

When operating in the connected mode 301, it may be required to perform a calibration of one or more RF components at the UE from time to time. Details with respect to a timing of the calibration are explained in connection with FIG. 6.

FIG. 6 schematically illustrates aspects with respect to an UCG 322. FIG. 6 illustrates operation of the UE 102 over time. The UE 102 persistently operates in the connected mode 301. Accordingly, the respective UE context is maintained at the cellular NW, e.g., at the AMF 131 or another CN node, specifying details of the data connection 189 between the UE 102 in the cellular NW.

Illustrated in FIG. 6 are time durations during which the UE 102 communicates payload data 311 using the data connection 189.

The respective transmission of the payload data 311—as well as other transmissions to and from the cellular NW 100—is suspended during the UCGs 322. I.e., the cellular NW schedules the UCGs 322 in that it stops scheduling the payload data transmission during the UCGs 322.

The UE 102 performs the calibration during the UCGs 322. This can include transmitting calibration signals 321. After completion of the calibration, the UCG 322 terminates, and the transmission of payload data can be resumed—without a need of transitioning into the connected mode 301, e.g., without requiring a RA procedure. This means that the UE 102 stays in the connected mode 301 during the UCG 322. The respective context can be retained at the cellular NW 100 during the UCG 322.

FIG. 6 illustrates that the UE 102 may access time-frequency resources 370 (simply, resources hereinafter) to perform the calibration, e.g., to transmit the calibration signals 321. The resources 370 are arranged during the UCG 322. There are generally various options for defining the resources 370.

TABLE 1

| Option | Example description |
|---|---|
| Type 1 - | Unscheduled time-frequency resources allow the UE to |
| unscheduled | perform an autonomous selection of the resources in the |
| resources | UCG 322 during which it accesses the spectrum for |
| | performing the calibration, e.g., for transmitting calibration |
| | signals. |
| | There is no requirement for the cellular NW to schedule |
| | the UE 102 to use the resources. A scheduling message |
| | is not required. |
| | The cellular NW may allocate the resources to other |
| | signals transmitted by other UEs, e.g., for UL transmission |
| | from the other UEs to the cellular NW. This means that the |
| | BS can schedule other UEs during the UCG 322. It would |
| | be possible that such allocation is restricted in accordance |
| | with one or more predefined rules, such as only allocating |
| | to UL communication, etc. |
| | Such scenario is simple from the NW scheduling aspect; |
| | however, it leaves the UE under calibration in an |
| | uncontrolled situation. Taking a power amplifier |
| | pre-distortion calibration as an example, a UE needs to |
| | transmit with a high power and probably over a large |
| | bandwidth to obtain the power-amplifiers non-linearity |
| | property and leaving such transmission uncontrolled, i.e. |
| | an uncontrolled environment, can cause severe interference |
| | to other communications nearby. |
| Type 2 - | The BS schedules the UE for performing the calibration on |
| Scheduled | specific resources. |
| resources | A scheduling message that is indicative of the scheduled |
| | resources may be communicated from the cellular NW to |
| | the UE 102. The respective resources allocated to the UE |
| | performing the calibration may also be predefined. |
| | The UE 102 may only access the spectrum in the resources |
| | allocated to performing the calibration, e.g., for |
| | transmitting calibration signals. |
| | This means that the BS considers that calibration signals |
| | will be transmitted at the respective time and frequency |
| | positions. Other signals may be allocated to different |
| | resources, to mitigate interference. |
| | The BS may or may not schedule other UEs during the |
| | resources allocated to the UE performing the calibration. |
| | In a case in which the BS schedules other UEs, the BS may |
| | schedule the other UEs to also perform respective |
| | calibrations of their RF components. |
| | It would also be possible that the resources are co- |
| | allocated to other types of signals, e.g., RA preambles or |
| | signals encoding payload data. |
| | Using scheduled resources can ensure the calibration to be |
| | performed in a controlled environment. However, |
| | scheduling can be complicated because even if the |
| | periodicity 325 of the UCGs is long compared to a |
| | duration 372 of radio frames or any event-triggered gaps |
| | are less frequent in the said time-frame, dependencies such |
| | as power levels and bandwidth changes imply multiple |
| | side conditions on scheduling all users, including those |
| | not requiring UCG. For multiple UEs, it becomes difficult |
| | to schedule multiple UCGs. |

Two options for implementing UCGs using either unscheduled resources or scheduled resources. Respective benefits and drawbacks are explained.

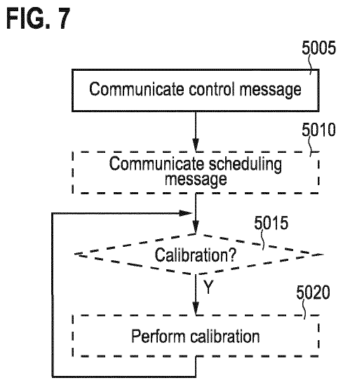

FIG. 7 is a flowchart of a method according to various examples. The method of FIG. 7 may be executed by a base station—e.g., the base station 101—and/or a UE—e.g., the UE 102. More specifically, it would be possible that the method of FIG. 7 is executed by the processor 1011 of the base station 101 upon loading program code from the memory 1015. It would also be possible that the method of FIG. 7 is executed by the processor 1021 of the UE 102, upon loading program code from the memory 1025. Optional boxes are illustrated using dashed lines.

At box 5005, at least one control message is communicated. For instance, the base station may transmit one or more of the at least one control message and/or the UE may receive one or more of the at least one control message. At least one of the one or more control messages can be a downlink control message. It would also be possible that at least one of the one or more control messages is an uplink control message.

The at least one control message is indicative of one or more parameters of a calibration to be performed by the UE. The at least one control message configures the calibration or is indicative of the configuration of the calibration. The control message can include assistance information for the UE and/or BS associated with said performing the calibration. The control message can, in other words, assist the UE in performing the calibration; alternatively or additionally, it can assist the BS in performing tasks associated with the calibration, e.g., allocating at least one resource to performing the calibration or scheduling one or more further UEs during the UCG and/or scheduling the UCG.

TAB. 2 illustrates examples of possible information content of the at least one control message.

TABLE 2

| | Brief | |
|---|---|---|
| | description | |
| | of content | Example details |
| I | Timing of | The at least one control message could be indicative of |
| | uplink | a timing of the UCG. |
| | calibration | For instance, a starting time could be indicated. It would |
| | | be possible to indicate a duration of the UCG. It would |
| | | be possible to indicate a timing schedule of multiple |
| | | reoccurring instances of the UCG. It would also be |
| | | possible that the at least one control message is |
| | | indicative of the calibration having been completed, so |
| | | that the UCG terminates. |
| | | Thereby, the BS may indicate to the UE the timing of |
| | | the UCG; or vice versa. |
| | | It is not required to indicate specific resources within |
| | | the UCG for performing the calibration. Such resources |
| | | may either be accessed autonomously the by the UE - |
| | | cf. TAB. 1: unscheduled resources - or a separate |
| | | scheduling message may be communicated, see box |
| | | 5010. |
| | | The timing of the UCG may be requested by the UE. |
| | | It would also be possible that the timing is instructed |
| | | by the cellular NW. A request-response pair of |
| | | multiple control messages may be possible. For |
| | | example, the UE may request a certain timing and the |
| | | cellular NW may send a response that is positively or |
| | | negatively acknowledging the requested timing. The UE |
| | | may request that the UCG should not occur later than |
| | | a certain maximum timing that could be signaled by |
| | | the UE. |
| II | Calibration | It would be possible that the at least one control |
| | signals to | message is indicative of one or more calibration signals |
| | use | used by the UE when performing the calibration. For |
| | | instance, a symbol sequence of the calibration signals |
| | | could be indicated. |
| | | This would facilitate code multiplexing with other |
| | | signals co-allocated to resources during the UCG. This |
| | | reduced interference. |
| III | Beams to | It would be possible that the at least one control |
| | use | message is indicative of one or more transmit (TX) |
| | | beams used by the UE to perform the calibration. It |
| | | would be possible to indicate which beams are selected |
| | | from a respective codebook. It would be possible to |
| | | indicate directions of respective beams. It would be also |
| | | be possible to indicate a beamwidth of such beams. |
| | | Another option would be to exclude certain beams, |
| | | directions etc. for being used by the UE during the |
| | | UCG. |
| | | The control message can include assistance |
| | | information that specifically assists the UE in the |
| | | selection of the appropriate TX beam for performing the |
| | | calibration. For instance, the assistance information can |
| | | specify constraints - cf. example V - in selecting the |
| | | respective beam, e.g., forbidden beams or forbidden |
| | | regions or forbidden beam widths. |
| IV | Request to | The UE may request, at the cellular NW, to perform |
| | perform | the calibration. The UE may indicate certain |
| | calibration | capabilities associated with performing the calibration. |
| | | The UE may indicate certain hardware constraints |
| | | associated with performing calibration. |
| | | For example, the UE may indicate that it requires the |
| | | calibration as soon as possible. The UE could also |
| | | request a certain periodicity of the UCG. The UE may |
| | | indicate that it prefers scheduled or unscheduled |
| | | resources for performing the calibration, cf. TAB. 1. |
| | | Thereby, the properties of the calibration can be |
| | | tailored to the needs of the UE. |
| V | Calibration | For example, timing constraints associated with the |
| | constraints | UCG could be signaled by the control message. For |
| | | instance, the UE may indicate certain maximum |
| | | allowed time offsets between subsequent UCGs. The |
| | | UE may indicate a maximum allowed time offset |
| | | between requesting an UCG and the UCG. The BS may |
| | | indicate a timing parameter associated with the |
| | | guaranteed availability of the UCG. |
| | | Beyond timing constraints, other types of constraints |
| | | are conceivable, e.g., transmit power constraints, |
| | | beam selection constraints - cf. example VI - etc. |
| | | Based on such calibration constraints, in particular |
| | | timing constraints, the BS and/or the UE can adjust |
| | | their operation in order to be able to comply with the |
| | | calibration constraints. For instance, the BS may not |
| | | schedule certain UEs during the UCG of another UE. |
| | | This can help for an overall more robust and reliable |
| | | communication. |

Multiple examples of information content of at least one control message communicated between the UE and the cellular NW. For instance, it would be possible that a request-response pair is implemented; here, the UE may initially request a certain configuration of the calibration and then the cellular NW may positively or negatively acknowledge the respective requested configuration. In other examples, it would be possible that the cellular NW proactively triggers a respective configuration of the calibration. The at least one control message may be communicated using Radio Resource Control (RRC) signaling on shared channels - e.g., physical uplink shared channel (PUSCH) and/or physical downlink shared channel (PDSCH).

At box 5010, it is then optionally possible to communicate a scheduling message, cf.

TAB. 1, scheduled resources. Here, resources allocated to the UE for performing the calibration can be indicated. The UE can access the spectrum using at least one of these resources allocated to performing the calibration, e.g., to transmit calibration signals.

As a general rule, according to various examples, the scheduling message may be broadcasted by the cellular NW. The scheduling message may also be transmitted in a one-to-one or one-to-many communication, e.g., to all UEs of a scheduling group.

The scheduling message may indicate a single set of at least one resources; or multiple repetitive resources.

The cellular NW—e.g., a scheduler functionality implemented by the BS—can transmit the scheduling message. The UE can receive the scheduling message.

Then, upon a need of performing the calibration—checked at box 5015—the UE can perform the calibration at box 5020. This can include transmitting calibration signals.

Typically, the UE may need to perform the calibration when operating in the connected mode 301. The UE—during the UCG—does not participate in payload data transmission. The UE does not transmit data to the cellular NW and does not receive data from the cellular NW. The UE can apply spatial precoding that is not suitable for communicating with the cellular NW; rather, the RF components can be tested using such spatial precoding. The UE can execute certain predefined transit routines as part of the calibration. The UE can stop listing to the cellular NW during the UCG.

As a general rule, according to the various examples described herein, a need to perform the calibration could be determined by monitoring operational characteristics of the one or more RF components subject to the calibration. For instance, if such operational characteristics degrade, the UE may determine that there is a need for performing the calibration. It would also be possible that the UE has a predefined timing defined with respect to the calibration, e.g., specifying that a calibration is to be performed every few seconds or so. Then, the need to perform the calibration may be determined in accordance with the predefined timing.

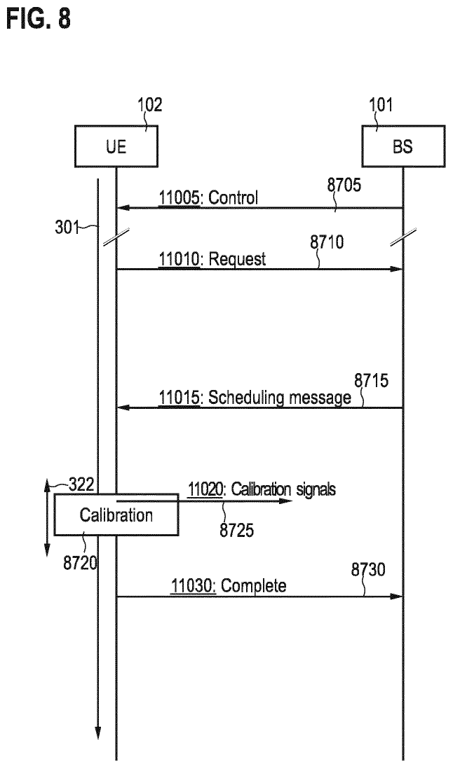

FIG. 8 is a signaling diagram illustrating communication between the BS 101 and the UE 102. The signaling illustrated in FIG. 8 is related to performing a calibration of one or more RF components at the UE 102. The UE 102 operates in the connected mode 301.

At 8705, the BS 101 transmits a control message 11005 and the UE 102 receives the control message 11005. The control message 11005 can be indicative of a configuration of the calibration. The control message 11005 can include assistance information for performing the calibration. Respective examples have been explained in connection with TAB. 2 above.

As a later point in time, at 8710, the UE 102 transmits a request message 11010. The request message 11010 requests an UCG 322. For instance, the request message could be indicative of a requested starting time of the UCG and/or a requested time duration of the UCG.

At 8715, the BS 101 transmits a scheduling message 11015 to the UE 102. The scheduling message is indicative of at least one resource allocated to the UE 102 performing the calibration. As such, the scheduling message may define a timing of the UCG. In a scenario in which the UE 102 has requested a certain timing of the UCG 322, the at least one resource can be allocated in accordance with the timing.

FIG. 8 illustrates a scenario of using scheduled resources, cf. TAB. 1. It would also be possible that unscheduled resources are used. Here, instead of transmitting the scheduling message 11015 to the UE 102, the BS 101 can transmit a further control message that is indicative of the timing of the UCG—e.g., start time and/or end time and/or duration, without indicating specific resources—and/or positively or negatively acknowledge the request for the UCG.

At 8720, the UE 102 performs the calibration. This includes transmitting calibration signals 11020 at 8725. In the illustrated example, the calibration signals 11020 are transmitted using the at least one resources indicated by the scheduling message 11015. Any communication between the UE 102 and the BS 101 can be prevented.

At 8730, the UE may then transmit a further control message 11030 that is indicative of the calibration having been completed.

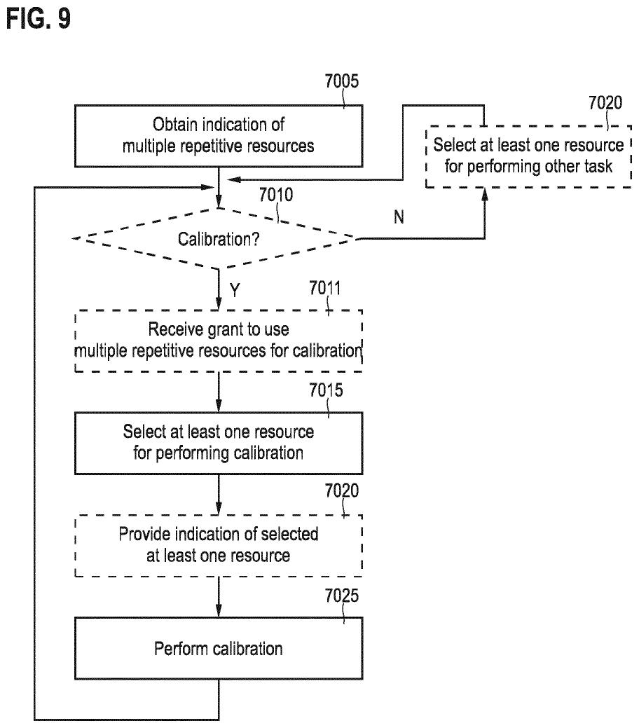

FIG. 9 is a flowchart of a method according to various examples. The method of FIG. 9 can be executed by a UE. For instance, the method of FIG. 9 could be executed by the UE 102. More specifically, the method of FIG. 9 could be executed by the processor 1021 of the UE 102, upon loading program code from the memory 1025. Optional boxes are illustrated using dashed lines.

At box 7005, the UE obtains an indication of multiple repetitive resources.

The multiple repetitive resources are thus distributed in time in a repetitive manner. Sets of one or more resources each can be re-occurring over the course of time. There is a time offset in between adjacent sets of one or more resources. For instance, adjacent sets of resources can be included in different subframes or system frames. For instance, the repetitive character of the multiple resources may be defined by a periodicity of the sets of one or more resources each; as well as a timing of the one or more resources of each set with respect to each other. The periodicity could be as long or longer than subframes of the transmission protocol. The periodicity could be longer than 0.5 ms or longer than 1 ms or even longer than 1 s.

There are various options available for implementing box 7005.

In one example, it would be possible that the multiple repetitive resources are predefined in accordance with a communication protocol used by the UE and the communications network to communicate with each other.

In such an example, it would be possible that the indication of the multiple repetitive resources includes loading respective control instructions from a memory of the UE. The control instructions can then be indicative of the multiple repetitive resources.

In another option, it would be possible that obtaining the indication of the multiple repetitive resources at box 7005 includes receiving a scheduling message from the communications network. The scheduling message can then be indicative of the multiple repetitive resources. Some aspects with respect to such a scheduling message have already been explained above in connection with FIG. 7: box 5010; in FIG. 8, scheduling message 11015.

To indicate the multiple repetitive resources, one or more of the following parameters summarized in TAB. 3 can be indicated.

TABLE 3

| | Information | |
|---|---|---|
| | element | Example description |
| I | Number of | The number of occurrences can specify how many |
| | occurrences | repetitions of the multiple repetitive resources will |
| | | be scheduled by the BS. For instance, each |
| | | repetition can include one or more resources. This |
| | | could be predefined or dynamically set. |
| II | Periodicity | The periodicity can specify a distance between |
| | | subsequent repetitions. |
| III | Time position | The time position can specify, for each repetition, |
| | | the timing of one or more respective resources of |
| | | the multiple repetitive resources. The time |
| | | position could be specified, e.g., with respect to |
| | | the beginning of a subframe or the beginning of a |
| | | time slot. |
| IV | Transport block | The transport block size can specify a count of re- |
| | size | sources for repetition. |
| V | Start time | The start time can indicate the first repetition of |
| | | the multiple repetitive resources, e.g., with respect |
| | | to the current time. |

Various information elements that can be included in a scheduling message for scheduling multiple repetitive resources that are allocated to the UE performing the calibration. It is possible that only some of these information elements are included, e.g., combined with further different information elements.

For example, the scheduling message could be broadcasted by the communications network. For instance, the scheduling message may be indicative of the multiple repetitive resources so that all UEs connected or about to connect to the cellular network may have access to the multiple repetitive resources. The scheduling message could be included or indicated by a synchronization signal block (SSB) broadcasted by the cellular network. For instance, the resources of the multiple repetitive resources may have predefined time offsets and/or frequency offsets with respect to SSBs broadcasted by the cellular NW in a repetitive manner.

In another variant, it would be possible that the scheduling message is communicated using a UE-specific data connection established between the UE and the communications network when the UE operates in a connected mode. Respective aspects have already been explained above in connection with FIG. 5: connected mode 301 and FIG. 4: data connection 189. For example, the scheduling message could be an RRC control message, e.g., communicated on the PDSCH supported by a data connection. The scheduling message could be defined on Layer 3. This is different to Downlink Control Information (DCI) typically defined on Layer 1 and used to schedule uplink data by allocating at least one non-repetitive resource.

As a general rule, the scheduling message could be proactively transmitted by the communications network. It would also be possible that the scheduling message is transmitted on-demand, e.g., triggered by a request from the UE (cf. TAB. 2, example IV). For example, it would be possible that the UE—prior to receiving the scheduling message—requests one or more UCGs for performing the calibration. Then, the scheduling message can be received in response to this request.

Prior to performing the calibration at box 7025, the UE can then select—at box 7015—at least one resource from the multiple repetitive resources for performing the calibration. This means that one or more of the multiple repetitive resources are chosen to perform the calibration. Calibration signals can be transmitted using the at least one selected resource, as already explained above in connection with FIG. 8: calibration signals 11020. The multiple repetitive resources thus could also be labeled candidate repetitive resources, because they may or may not be selected by the UE for transmitting the calibration signals. The multiple repetitive resources thus represent the pool of resources distributed over time for which the UE can choose one or more resources for performing the calibration.

In particular, the multiple repetitive resources can be obtained by the UE prior to a need of performing the calibration. I.e., when selecting the at least one resource at box 7015, the UE may previously already have obtained knowledge of the multiple repetitive resources. As such, the multiple repetitive resources may be predefined with respect to the selection of the at least one resource for performing the calibration at box 7015.

There are various trigger criteria are conceivable for selecting the at least one resource for performing the calibration at box 7015. Such trigger criteria can be optionally checked at box 7010. At optional box 7010, the UE may determine whether there is a need for performing the calibration. Then, the at least one resource can be selected in response to such a need for performing the calibration.

Details with respect to determining whether there is a need to perform the calibration have been discussed in connection with FIG. 7: box 5015. Typically, the UE may need to perform the calibration from time to time when operating in a connected mode and when communicating payload data, e.g., on PUSCH and/or PDSCH. This communication of payload data is then temporarily suspended when performing the calibration, during the UCG.

Upon selecting the at least one resource at box 7015, it is optionally possible that the UE provides an indication of the selected at least one resource to the cellular NW at box 7020. Then, it would be possible that the UE expects a positive or negative acknowledgment from the cellular network specifying whether it is allowed or not allowed to perform the calibration using the at least one resource. Only in the affirmative, the UE may perform the calibration at box 7025 using the at least one resource, e.g., by transmitting one or more calibration signals using the at least one resource selected at box 7015; otherwise, the UE may select another at least one resource for performing the calibration or may receive a further scheduling message for a further at least one resource for performing the calibration from the cellular NW, as a fallback.

According to various examples described herein, the multiple repetitive resources can thus be configured periodically or semi-persistently.

A periodic configuration means that the multiple repetitive resources are statically reoccurring. I.e., sets of one or more resources each are repeated statically. Semi-persistently means that the multiple repetitive resources are re-occurring within a certain time window. The network can configure the semi-persistently configured multiple repetitive resources it with different repetition rates according the demand of the calibration.

A single scheduling message may define multiple instances of the resources. For instance, the resources may be reoccurring over the course of multiple subframes or frames of a communication protocol used by the cellular NW and the UE to communicate with each other. In particular, the multiple repetitive resources may be spread out over a time duration over which typical multiple instances of the calibration are required. For example, it would be possible that a calibration is required every few seconds or every few tens of seconds. Accordingly, the multiple repetitive resources can span a time duration that is as long as multiple seconds or multiple tens of seconds or longer. This is much longer than a duration of a subframe, e.g., in the order of 0.5 milliseconds.

According to the various examples described herein, the multiple repetitive resources may not be exclusively allocated to the UE performing the calibration. Rather, it would be possible that the multiple repetitive resources are co-allocated to multiple different types of signals. This means that the multiple repetitive resources can be re-used by the UE and/or multiple UEs—in which case they are shared between multiple UEs, e.g., in a contention-based manner—to transmit multiple different types of signals. Some possible types of signals that can be co-allocated to the multiple repetitive resources are summarized in TAB. 4 below.

TABLE IV

| | Examples for signal | |
|---|---|---|
| | types co-allocated to | |
| | the multiple repetitive | |
| | resources, in addition | |
| | to allocation to | |
| | performing calibration | Detailed examples |
| I | Payload data | To transmit payload data, typically, a data |
| | transmitted in idle | connection is established when the UE |
| | mode, e.g., PUR | transitions to operating in the connected |
| | | mode. According to various examples, the |
| | | multiple repetitive resources can be co- |
| | | allocated to signals that cenode payload data |
| | | transmitted when operating in an idle mode, |
| | | i.e., without a data connection having been |
| | | established. This may take place before or |
| | | without performing a random-access |
| | | procedure. Respective examples have been |
| | | described in connection with the idle mode |
| | | 302 in FIG. 5 for PUR. |
| | | The scheduling of PUR resources is mainly |
| | | intended for UEs with either periodic and/or |
| | | semi-persistent traffic. |
| | | For the multi-user case, configuring PUR for |
| | | data transmission to be shared by up to two |
| | | users is already supported. Since the BS does |
| | | not need to decode the uplink transmission |
| | | during the UCG, the PUR in this case can |
| | | also be optionally shared by multi-users (>2). |
| | | By reusing PUR resources for calibration, the |
| | | scheduling can be simplified. A high degree |
| | | of flexibility in determining respective |
| | | resources can be achieved, e.g., a larger or |
| | | smaller time-domain density of the repetitive |
| | | resources may be determined. |
| II | RA preambles | When performing a RA procedure, the UE |
| | | transmits a RA preamble. The RA preamble |
| | | is selected from a set of candidate RA |
| | | preambles, as explained above in connection |
| | | with FIG. 5. |
| | | The multiple repetitive resources can be co- |
| | | allocated to transmitting RA preambles and |
| | | calibration signals. |
| | | Such techniques are based on the finding that |
| | | the RA procedure provides for rules to |
| | | resolve collision, e.g., by implementing a |
| | | random backoff and using code-orthogonal |
| | | preambles. Thus, a situation may occur where |
| | | the UE uses at least one resource for |
| | | performing the calibration and a further UE |
| | | uses the same at least one resource for |
| | | transmitting a RA preamble in a contention- |
| | | based manner; a collision results. The RA |
| | | procedure of the further UE may in some |
| | | situations fail due to interference caused by |
| | | the UE performing the calibration. Then, |
| | | predefined rules for resolving such collision |
| | | are already available in the context of the RA |
| | | procedure, e.g., the further UE may perform a |
| | | random back-off and retry RA at a later point |
| | | in time. |
| | | Multiple repetitive resources allocated to the |
| | | transmission of RA preambles are |
| | | broadcasted by the cellular network using |
| | | SSBs (as a scheduling message). Such |
| | | transmission of SSBs is typically always-on. |
| | | Each SSB can have at least one resource |
| | | associated to it, e.g., at a fixed time and/or |
| | | frequency offset. Thereby, by the repetitive |
| | | transmission of the synchronization signal |
| | | blocks, the occurrence of the multiple |
| | | repetitive resources is defined. |
| | | The number of resources associated with each |
| | | SSB can be configured. Thereby, the cellular |
| | | NW can dynamically adjust this ratio |
| | | depending, e.g., on the initial access node |
| | | and/or the load of UEs requiring to perform |
| | | the calibration. Thus, the cellular NW can |
| | | dynamically determine the count of repetitive |
| | | resources per time unit. |
| | | A respective physical RA channel (PRACH) |
| | | is located in uplink timeslots. Therefore, by |
| | | co-allocating respective multiple repetitive |
| | | resources also to the UE performing the |
| | | calibration, this does not create direct |
| | | interference to other UEs. |
| | | According to various examples, it would be |
| | | possible that one or more calibration signals |
| | | mtransitted when performing the calibration |
| | | orthogonal to at least some of multiple |
| | | candidate preambles of the RA procedure in |
| | | code domain. Thereby, collision between the |
| | | UE transmitting the one or more calibration |
| | | signals when performing the calibration using |
| | | the at least one resource and a further UE |
| | | transmitting a RA preamble selected from the |
| | | multiple candidate preambles can, at least in |
| | | some cases, be resolved by code |
| | | multiplexing. |
| | | For instance, it would be possible that a |
| | | control message transmitted by the |
| | | communications network to the UE (cf. FIG. |
| | | 7: box 5005; FIG. 8, the control message |
| | | 11005) is indicative of the calibration signals |
| | | that are allowed to be used by the UE. Cf. |
| | | TAB. 2: example II. |

Various options for types of signals to which the multiple repetitive resources can be co-allocated, beyond the allocation to performing the calibration. These are only some examples. Other examples such as reference signals or positioning signals are also conceivable.

In order to enable the cellular NW to have control over the types of signals transmitted using the multiple repetitive resources, it would be possible that the UE receives a grant to access the multiple repetitive resources for performing the calibration. The grant can be communicated separately from the scheduling message, as illustrated in FIG. 9 by box 7011.

For example, some BSs of a cellular NW may support use of the multiple repetitive resources for performing the calibration, while other BSs may not support this feature. Different operators of different cellular NW's may activate or deactivate this feature. It would also be possible that this feature is dynamically activated and deactivated, e.g., depending on one or more decision criteria such as: traffic load at a cell of the cellular NW; coverage scenario of a UE; service level of payload data communicated between the cellular NW and the UE; etc.

Above, various examples have been described how the multiple repetitive resources can be co-allocated to multiple types of signals. As a general rule, it would be possible that multiple UEs use the multiple repetitive resources to transmit signals of the different multiple types. For instance, two different UEs may use the same at least one resource of the multiple repetitive resources to transmit signals of different types—i.e., the at least one resource can be shared. Alternatively or additionally to such use of the multiple repetitive resources by multiple UEs, it would also be possible that the multiple repetitive resources are used by a given UE to transmit, at different points in time, different types of signals using different at least one resource is selected from the multiple repetitive resources. This is also illustrated in connection with FIG. 9.

For instance, if the UE judges at box 7010 that there is no need to perform the calibration, it may select, at box 7020 at least one resource for performing another task, different from performing the calibration, i.e., to transmit another type of signals, e.g., one of the signal types discussed in connection with TAB. 4.

As a general rule, it is possible that the UE thus selects a first resource of the multiple repetitive resources for performing the calibration and, at another point in time, selects at least one second resource of the multiple repetitive resources—different from the at least one first resource—for transmitting a signal encoding payload data when operating in an idle mode. See TAB. 4: example I. It would also be possible that the UE selects the at least one second resource for transmitting a RA preamble, when operating in the idle mode, e.g., prior to a transition to the connected mode. Accordingly, the at least one first resource and the at least one second resource thus can both be scheduled using one and the same scheduling message. The UE can continue to access the multiple repetitive resources before and after transitioning between the connected mode and the idle mode.

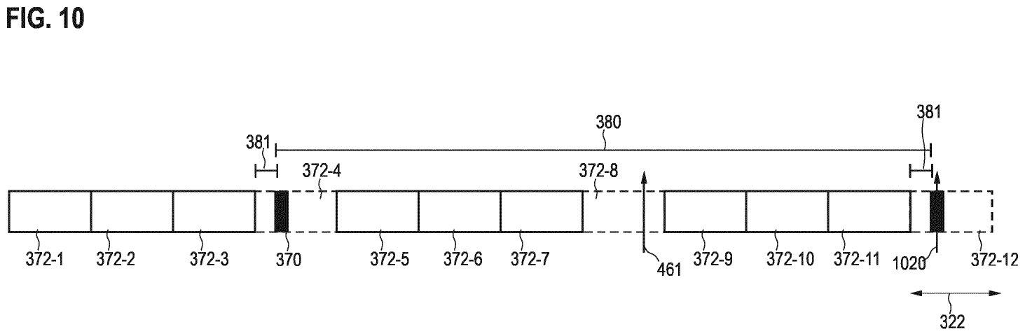

FIG. 10 illustrates aspects with respect to multiple repetitive resources. FIG. 10 illustrates a sequence of multiple subframes 372-1-372-12. Each subframe 372-1-372-12 includes a number of time-frequency resources.

A set of resources of the multiple repetitive resources 370 is allocated to the UE 102 performing the calibration in the subframe 372-4. A further set of resources of the multiple repetitive resources 370 is allocated to the UE 102 performing the calibration in the subframe 372-12. Each set of resources can include one or more resources. The UE may select all resources of a set or only a subfraction of all resources of the set for performing the calibration.

In the illustrated example of FIG. 10, a periodicity 380 of the multiple repetitive resources is labeled (cf. TAB. 3: example II). Also, a time position 381 of each set of resources of the multiple repetitive resources with respect to a beginning of the respective subframe 372-4 and 372-12 is illustrated (cf. TAB. 3: example V). Such and other parameters can be indicated by the scheduling message scheduling the multiple repetitive resources.

In the illustrated example of FIG. 10, the UE 102 transmits a control message 461 that is indicative of the selection of the at least one resource of the multiple repetitive resources in the subframe 372-12. Accordingly, the BS can then schedule an UCG 322 that includes, at least, the subframe 372-12 and the UE can access the at least one resource of the multiple repetitive resources in the subframe 372-12 for transmitting one or more calibration signals 11020.

For example, the multiple repetitive resources in the example of FIG. 10 could be co-allocated to RA preambles (cf. TAB. 4, example II). Then, the multiple repetitive resources can be indicated by SSBs (not shown in FIG. 10). The cellular NW, upon receiving the control message 461 that is indicative of the intention of the UE 102 to use the next RA occasion for calibration, can acknowledge this intention. As an alternative, the using of PRACH for UL calibration could also be explicitly stated in the specification. Then a request-grant-pair may not be required. The BS could also broadcast that the use of the PRACH resources is allowed for performing the calibration.

As a general rule, the cellular NW may or may not indicate the exact PRACH occasion that the UE shall use for performing the calibration. In the latter case, the scheduling of the multiple repetitive resources—i.e., the occasion of the PRACH occasion or PRACH occasions used for calibration—can be obtained from the SSBs. As the UE needs to continuously monitor the SSBs, it is feasible for the UE to know the coming PRACH occasions without additional network signaling.

The network may optionally configure the calibration signal that the UE could use for the calibration, such that it will be orthogonal to the preambles that used for normal RACH to avoid increasing the collisions or interference level for PRACH. For example, this can be done by reserving a group of preambles for initial access, and another (orthogonal) group of preambles for UL gap calibration. This has been discussed in connection with TAB. 2, example II.

It has been found that the design of the PRACH can be suboptimal for the purpose of performing calibration. Therefore, its configuration may not be flexible enough for the UE to reach an optimized calibration. As an alternative solution multiple repetitive resources for PUR can also be re-used for performing the calibration (cf. TAB. 4, example I).

The cellular NW can re-use PUR resources for calibration purposes, once it knows the UE can do uplink calibration. As the UE capability would be reported when the UE is connected to the network, the network can thus preconfigure the UL resources to the UE. In this case, the network will not need to dynamically adjust the uplink resources for the UE due to the request of UCG.

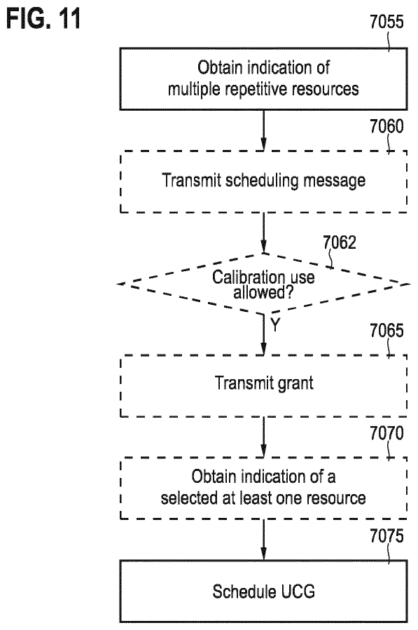

FIG. 11 is a flowchart of a method according to various examples. The method of FIG. 11 could be executed by a BS. Specifically, the method of FIG. 11 could be executed by the BS 101. For example, the method of FIG. 11 could be executed by the processor 1011 of the BS 101, upon loading program code from the memory 1015. Optional boxes are labeled with dashed lines. The BS is connected or connectable to a UE. The BS is part of a cellular NW.

At box 7055, the BS obtains an indication of multiple repetitive resources that the UE is allowed to use for performing a calibration of one or more RF components of the UE. The multiple repetitive resources are thus allocated to the UE performing the calibration. Box 7055, accordingly, corresponds to box 7005 of the method of FIG. 9.

It is possible that the multiple repetitive resources are predefined in accordance with a communication protocol used by the BS and the UE to communicate with each other. Then, obtaining the indication of the multiple repetitive resources at box 7055 can include loading respective control instructions from a memory of the BS, wherein the control instructions are indicative of the multiple repetitive resources.

It would also be possible that the multiple repetitive resources are not predefined. In this scenario, the BS can determine the multiple repetitive resources to the UE performing the calibration.

At least in a scenario in which the multiple repetitive resources are not predefined, the BS can then transmit a scheduling message at box 7060 to the UE. Details with respect to such scheduling message have been discussed above in connection with box 7005 of the method of FIG. 9.

When the multiple repetitive resources are not predefined, but rather newly/dynamically determined by the BS, various decision criteria can be taken into account. For instance, it would be possible that the multiple repetitive resources are determined based on at least one of a load situation at the communications network, a coverage situation of the UE, or a service level of payload data communicated between the UE and the communications network.

For example, the load situation may pertain to a number of UEs currently being connected to the BS. For example, the load situation may pertain to a number of UEs currently performing a random access. The load situation of the cellular NW can be associated with a count of UEs connected to a respective cell of the BS, or the data rate overall served, etc. Higher load situations can be associated with increased risk for collision—such that there may be a tendency of reduced availability of repetitive resources allocated to performing the calibration. On the other hand, higher throughputs can be required in high-load situations—such there is an opposite trend of required higher availability of such repetitive resources allocated to performing the calibration. A sweet spot may be available.

The coverage situation of the UE can pertain to whether the UE is located at a cell edge of a cell supported by the BS were located at a cell center. The transmission parameters can vary depending on the coverage situation. Accordingly, the UE may have different needs to perform a calibration, depending on the coverage situation. The coverage level can be determined based on sounding one or more spatial propagation paths between the UE and the BS using reference signals. Typically, different modulation and coding schemes may be employed for supporting the communication in a cell-edge scenario if compared to a cell-center scenario; along with different modulation and coding schemes employed by the UE for a transmission of payload data, different a calibration may be required more often or less frequently.

The service level of payload data can correspond to the quality of service requirements associated with the payload data. For example, the service level could pertain to a required data throughput, a required latency, a required jitter, etc. Typically, such service levels then impose restrictions on the transmission parameters to be used; and, along with varying transmission parameters, also the need to perform a calibration may vary. The service level could indicate certain constraints for latency, jitter and/or bit loss, or other figures of merit. Lower latency and jitter typically requires more accurate calibration; such that more repetitive resources may be allocated to performing the calibration per time unit.

Scenarios have been discussed above in which the multiple repetitive resources are also allocated to other types of signals. In particular, it would be possible that the multiple repetitive resources are primarily allocated to other types of signals, i.e., only secondarily allocated to the UE performing the calibration. In such a scenario, it would be possible that the BS determines, at box 7062, whether the UE is allowed to use the multiple repetitive resources for performing the calibration, or whether the UE should not be allowed to use the multiple repetitive resources for performing the calibration. In the affirmative, the BS may transmit, to the UE, at box 7065, a grant to use the multiple repetitive resources for performing the calibration. Respective aspects have been discussed above in connection with the method of FIG. 9, box 7011.

Various decision criteria can be taken into account when determining whether the UE should be allowed to use the multiple repetitive resources for performing the calibration at box 7062. In particular, similar decision criteria can be taken into account as those discussed in connection with box 7055 when determining the multiple repetitive resources. I.e., decision criteria such as the coverage situation of the UE and/or a service level of payload data communicated between the UE and the communications network and/or a load situation at the communications network should be taken into account when determining whether the UE is allowed to use the multiple repetitive resources for performing the calibration at box 7062.

In particular, it is possible that other types of signals (co-)allocated to the multiple repetitive resources prevent further allocation of the multiple repetitive resources to the UE performing the calibration. Examples of other types of signals that can be allocated to the multiple repetitive resources have been discussed above in connection with TAB. 4. For instance, a scenario would be conceivable where the load situation at the BS indicates that there is a significant number of UEs attempting to connect to the cellular NW by performing the RA procedure. Then, if the multiple repetitive resources are allocated to the RA preambles of the RA procedure, a scenario would be conceivable where use of the multiple repetitive resources for performing the calibration is, at least temporarily, not allowed. A similar consideration also applies for a scenario in which the multiple repetitive resources are allocated to uplink payload data transmitted in idle mode, e.g., PUR, as discussed in connection with TAB. 4, example I. Here, if there are multiple further UEs that transmit such payload data during respective idle mode operation, a scenario can occur in which further use of the multiple repetitive resources for performing the calibration is not feasible. Then, the UE may not be allowed to use the multiple repetitive resources for performing the calibration.

At box 7070, the BS may obtain an indication of a selected at least one resource from the UE. The at least one resource can be selected from the multiple repetitive resources. This has been discussed in connection with the method of FIG. 9: box 7015, box 7020. Then, the BS can schedule an UCG for the UE in accordance with the selected at least one resource. In particular, communicating payload data between the BS and the UE can be suspended during the UCG.

Summarizing, above, various examples have been described that facilitate using scheduled resources for performing a calibration at the UE. This helps to mitigate interference. By using multiple repetitive resources, the scheduling overhead can be reduced. Furthermore, scenarios have been described in which the multiple repetitive resources are co-allocated to further types of signals, which helps to further reduce the scheduling overhead.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

1. A method of operating a wireless communication device connectable to a communications network, the method comprising:
obtaining an indication of multiple repetitive resources that the wireless communication device is allowed to use for performing a calibration of one or more radio-frequency components, and
prior to performing the calibration: selecting at least one resource from the multiple repetitive resources for performing the calibration.

2. The method of claim 1, wherein the multiple repetitive resources are periodically or semi-persistently configured.

3. The method of claim 1, wherein said obtaining of the indication of the multiple repetitive resources comprises receiving a scheduling message from the communications network, the scheduling message being indicative of the multiple repetitive resources.

4. The method of claim 3, wherein the scheduling message is broadcasted by the communications network.

5. The method of claim 3, wherein the scheduling message is communicated using a data connection established between the wireless communication device and the communications network when the wireless communication device operates in a connected mode.

6. The method of claim 3, further comprising:
requesting one or more uplink calibration gaps for performing the calibration, a transmission of payload data using a data connection between the wireless 38 communication device and the communications network when the wireless communication device operates in a connected mode being suspended during the one or more uplink calibration gaps, wherein the scheduling message is received in response to requesting the one or more uplink calibration gaps.

7. The method of claim 1, wherein the multiple repetitive resources are pre-defined in accordance with a communication protocol used by the wireless communication device and the communications network to communicate with each other, wherein said obtaining the indication of the multiple repetitive resources comprises loading control instructions from a memory of the wireless communication device, the control instructions being indicative of the of the multiple repetitive resources.

8. The method of claim 1, further comprising:
upon selecting the at least one resource: providing an indication of the selected at least one resource to the communications network and optionally obtaining a grant to access the selected at least one resource.

9. The method of claim 1, wherein the at least one resource is selected in response to a need for performing the calibration.

10. The method of claim 1, further comprising:
receiving, from the communications network, a grant to access the multiple repetitive resources for performing the calibration.

11. The method of claim 1, wherein the multiple repetitive resources are co-allocated to different types of signals, depending on an operational mode of the wireless communication device.

12. The method of claim 1, further comprising:—communicating payload data between the wireless communication device and the communications network using a data connection established when the wireless communication device operates in a connected mode, and
while performing the calibration: suspending said communicating of the payload data between the wireless communication device and the communications network and maintaining the data connection.

13. The method of claim 1, wherein the multiple repetitive resources are allocated to the calibration and furthermore co-allocated to payload data transmitted when operating in an idle mode when a data connection between the wireless communication device and the communications network is not established.

14. The method of claim 1, furthermore comprising:
selecting at least one further resource of the multiple repetitive resources, and
accessing the at least one further resource for transmitting uplink payload data when operating in an idle mode during which a data connection is not established between the wireless communication device and the communications network.

15. The method of claim 1, further comprising:
continuing to access the multiple repetitive resources before and after transitioning between a connected mode during which a data connection is established between the wireless communication device and the communications network, and an idle mode during which the data connection is not established.

16. The method of claim 1, wherein the multiple repetitive resources are allocated to the calibration and furthermore allocated to random-access preambles of a random-access procedure.

17. The method of claim 1, further comprising:
selecting at least one further resource of the multiple repetitive resources for transmitting a random-access preamble of a random-access procedure, and—accessing the at least one further resource for transmitting the random-access preamble.

18. The method of claim 17, further comprising:
selecting the random-access preamble from a set of candidate preambles, wherein performing the calibration comprises transmitting a calibration signal, wherein at least some of the candidate preambles are orthogonal to the calibration signal.

19. The method of claim 1, further comprising:
receiving, from the communications network, a control message indicative of calibration signal transmitted when performing the calibration.

20. The method of claim 1, wherein the multiple repetitive resources are shared in a contention-based manner by multiple wireless communication devices.

21-34. (canceled)
